(19) United States
(12) Patent Application Publication
(10) Pub. No.: US 2016/0042554 A1
(43) Pub. Date: Feb. 11, 2016

(54) METHOD AND APPARATUS FOR GENERATING REAL THREE-DIMENSIONAL (3D) IMAGE

(71) Applicant: SAMSUNG ELECTRONICS CO., LTD., Suwon-si (KR)

(72) Inventors: Gurel OGAN, Seongnam-si (KR); Hongseok LEE, Seongnam-si (KR)

(73) Assignee: SAMSUNG ELECTRONICS CO., LTD., Suwon-si (KR)

(21) Appl. No.: 14/669,539

(22) Filed: Mar. 26, 2015

(30) Foreign Application Priority Data
Aug. 5, 2014 (KR) 10-2014-0100702

(51) Int. Cl. G06T 15/20; G06F 3/0484; G06F 3/01; G06T 19/20; G06F 3/0481

(52) U.S. Cl. CPC G06T 15/205; G06T 19/20; G06F 3/04815; G06F 3/017; G06F 3/04842; G06F 3/013; G06T 2207/20104

(57) ABSTRACT

Provided are a method and system for generating a three-dimensional (3D) image. The method includes generating a first 3D image having a first binocular depth cue and a first monocular depth cue, and generating, in a first region a second 3D image that has a second binocular depth cue and a second monocular depth cue and is different from the first 3D image, in response to a user command being input which indicates that the first region is selected from the first 3D image, wherein the first and the second 3D images represent a same object.

### CROSS-REFERENCE TO RELATED APPLICATION

This application claims priority from Korean Patent Application No. 10-2014-0100702, filed on Aug. 5, 2014, in the Korean Intellectual Property Office, the disclosure of which is incorporated herein in its entirety by reference.

### BACKGROUND

1. Field

The present disclosure relates to methods and apparatuses for generating a real three-dimensional (3D) image.

2. Description of the Related Art

There is an increasing need for 3D image generating devices in various fields such as medical imaging, gaming, advertisement, education, and military affairs, since such devices can represent images in a more realistic and effective way than other type of devices. Technologies for displaying a 3D image are classified into a volumetric type, holographic type, and stereoscopic type.

A stereoscopic method is a stereographic technique that uses physiological factors of both eyes that are spaced apart by approximately 65 mm to give a perception of depth. In detail, this method uses stereography that provides a sensation of depth by creating information about a space as the brain combines associated images of a plane containing parallax information, which are seen by the left and right eyes of a human viewer.

However, the stereoscopic method relies only on binocular depth cues such as binocular disparity or convergence and does not provide monocular depth cues such as accommodation. A lack of a monocular depth cue may trigger disharmony with a depth cue generated by binocular disparity and is a major cause of visual fatigue.

Unlike a stereoscopic method, a volumetric method and a holographic method may generate a realistic 3D image that does not cause visual fatigue since they provide both a binocular depth cue and a monocular depth cue. A 3D image in which an eye convergence angle and a focus of an image coincide with each other by providing the binocular and monocular depth cues is referred to as a real 3D image. However, it is difficult to generate the real 3D image since this requires a large amount of calculation.

### SUMMARY

Provided are methods and apparatuses for generating a detailed region of interest (ROI) in a three-dimensional (3D) image containing a depth cue therein.

Additional aspects will be set forth in part in the description which follows and, in part, will be apparent from the description, or may be learned by practice of the presented embodiments.

According to an aspect of an example embodiment, a method of generating a 3D image may include: generating a first 3D image having a first binocular depth cue and a first monocular depth cue; and generating, in a first region, a second 3D image that has a second binocular depth cue and a second monocular depth cue and is different from the first 3D image, in response to a user command being input which indicates that the first region is selected from the first 3D image, wherein the first and the second 3D images represent a same object.

The method may further comprise generating, in a second region a third 3D image that has a third binocular depth cue and a third monocular depth cue and is different from the first 3D image, in response to a user command being input which indicates that the second region is selected from the first 3D image, and wherein the first and the third 3D images represent the same object.

The user command indicating that the first region may be selected and the user command indicating that the second region is selected may be input by different users.

The second 3D image may have a second resolution that is different from a first resolution of the first 3D image.

The second resolution is higher than the first resolution.

The first and the second 3D images may show different entities of the same object.

The first 3D image may show an appearance of the same object, and the second 3D image may show an inside of the same object.

The first and the second 3D images may show a first entity and a second entity contained inside the same object, respectively.

The second 3D image may be generated in the first region by overlapping with the first 3D image.

The second 3D image may be displayed in the first region by replacing a portion of the first 3D image.

The first region may be determined by at least one from among a user's gaze and a user's motion.

The first region may be a region indicated by a portion of a user's body or by an indicator held by the user.

The portion of the user's body may comprise at least one selected from a user's pupil and a user's finger.

The second 3D image may vary according to the user's motion.

The first or second 3D image may be generated using a computer generated hologram (CGH).

The first and the second 3D images may be medical images.

According to another aspect of an example embodiment, a system for generating a three-dimensional (3D) image may include: a panel configured to generate a first 3D image; and a sensor configured to detect at least one from among a user's position and a user's motion, and wherein the panel generates a second 3D image different from the first 3D image in a first region, in response to a result of the detection indicating that the first region is selected from the first 3D image.

The second 3D image may represent a same object as the first 3D image and has a second resolution that is different from a first resolution of the first 3D image.

The first and the second 3D images may show different entities of the same object.

The first 3D image may show an appearance of the object, and the second 3D image may show an inside of the object.

According to another aspect of an exemplary embodiment, a system for generating a three-dimensional (3D) image may comprise: a sensor configured to detect a pupil position or a hand gesture of a user; and a processor configured to generate an original version of a 3D image and to generate a new version of the 3D image in response to the detected pupil position or the hand gesture indicating that the user selects a region of the original version of the 3D image, wherein the new version is provided with a remaining region having a resolution that is the same as a resolution of the original version and the selected region having a resolution higher than the resolution of the original version.

The processor may generate the new version in response to the detected pupil position indicating that the user gazes at the selected region of the original version.

The processor may generate the new version in response to the detected hand gesture further indicating that two fingers of the user spread while the user gazes at the selected region of the original version.

### BRIEF DESCRIPTION OF THE DRAWINGS

These and/or other aspects will become apparent and more readily appreciated from the following description of the embodiments, taken in conjunction with the accompanying drawings in which:

FIG. 1 schematically illustrates a system for generating a real three-dimensional (3D) image according to an exemplary embodiment;

FIG. 2 is a block diagram of the system of FIG. 1;

FIGS. 3A and 3B schematically illustrate a panel for generating a holographic image according to an exemplary embodiment;

FIG. 4A schematically illustrates a panel for generating a volumetric image according to an exemplary embodiment;

FIG. 4B schematically illustrates a panel for generating a volumetric image according to another exemplary embodiment;

FIG. 5 is a flowchart of a method of generating a real 3D image according to an exemplary embodiment;

FIGS. 6A through 6D are diagrams for explaining a method of generating a real 3D image according to an exemplary embodiment;

FIGS. 7A and 7B are diagrams for explaining a method of generating a real 3D image according to gaze behaviors of a plurality of users, according to an exemplary embodiment; and

FIGS. 8A through 8C are diagrams for explaining a method of generating a real 3D image according to another exemplary embodiment.

### DETAILED DESCRIPTION

Exemplary embodiments will now be described more fully hereinafter with reference to the accompanying drawings. In the drawings, like reference numerals refer to like elements throughout, and repeated descriptions thereof will be omitted herein. Expressions such as “at least one of,” when preceding a list of elements, modify the entire list of elements and do not modify the individual elements of the list.

As described above, a real three-dimensional (3D) image contains depth cues therein and may be an image generated by a holographic method or a volumetric method. The depth cues include a binocular depth cue and a monocular depth cue. In addition, the real 3D image may include an image generated by using a super multiview method. Hereinafter, for convenience of explanation, exemplary embodiments will mainly be described with respect to a holographic image and a volumetric image.

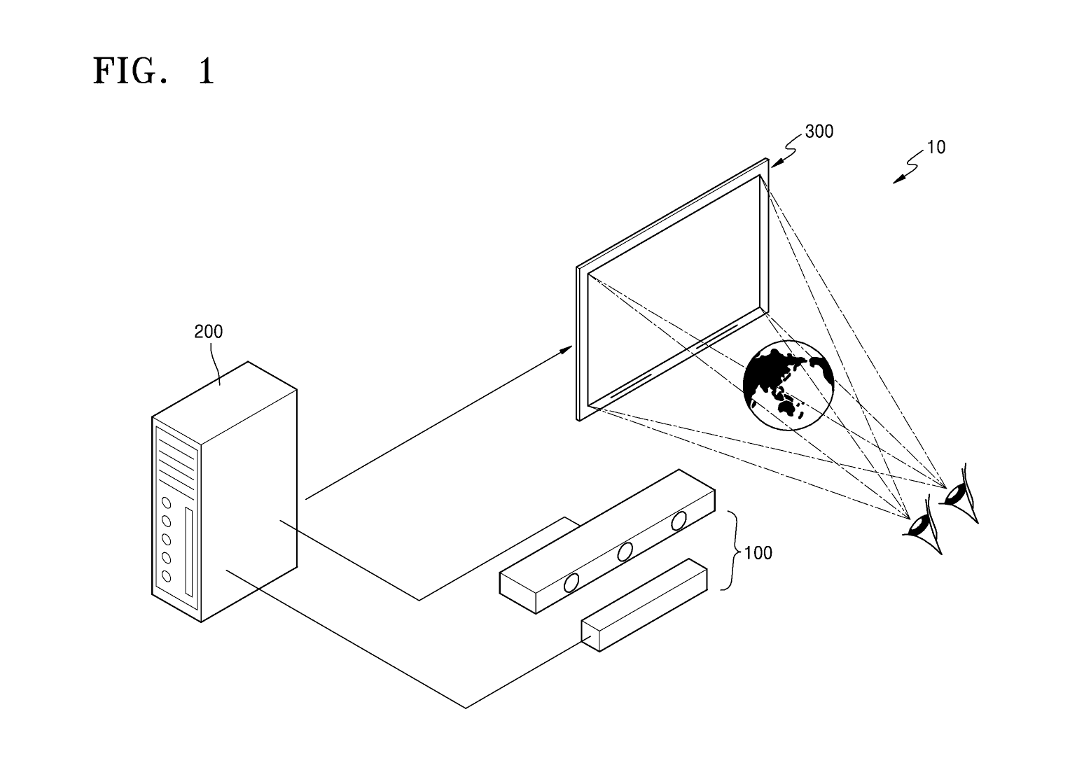

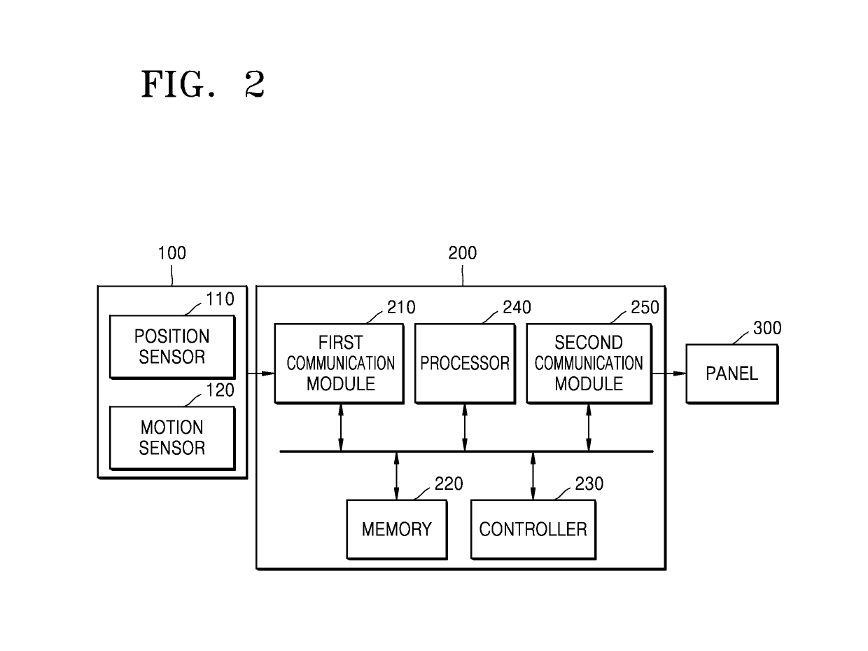

FIG. 1 schematically illustrates a system 10 for generating a real 3D image (hereinafter, referred to as a ‘real 3D image system’) according to an exemplary embodiment, and FIG. 2 is a block diagram of the real 3D image generation system 10. Referring to FIGS. 1 and 2, the real 3D image generation system 10 may include a sensor 100 for detecting at least one selected from a position and a motion of a user, a processor 200 for generating an image signal corresponding to one of the position and the motion of the user, and a panel 300 for generating a real 3D image corresponding to the image signal. In FIGS. 1 and 2, the real 3D image generation system 10 may be mountable, but is not limited thereto. The real 3D generation system 10 may be a portable type or a projection type.

The sensor 100 may include a position sensor 110 for detecting a position where a user's gaze is directed and a motion sensor 120 for detecting a user's motion. The position sensor 110 may detect the user's gaze, or a position indicated by a portion of the user's body such as a pupil or finger, or an indicator (e.g., a bar) held by the user. The position sensor 110 may include a camera that may be disposed inside or outside the processor 200 or the panel 300, a magnetic field generator attached to a user or indicator, a sensor for sensing a change in a magnetic field, or a sensor for detecting a change in capacitance according to a position of a user or indicator.

The motion sensor 120 may detect a motion of a user's whole body or a portion thereof such as a finger. The motion sensor 120 may be an acceleration sensor, a gyro sensor, a terrestrial magnetic sensor, or other sensors designed to recognize a user's motion.

The processor 200 may include a first communication module 210 for receiving at least one of signals indicating the user's position and motion from the sensor 100, a memory 220 for storing various data necessary to generate a real 3D image, a controller 230 for controlling the processor 200 in response to signals indicating the user's position and motion, a processor 240 for processing or generating an image signal corresponding to a real 3D image, and a second communication module 250 for transmitting the image signal to the panel 300. All the components shown in FIG. 2 are not essential components, and the processor 200 may further include components other than the components shown in FIG. 2.

The first communication module 210 may receive at least one selected from information about a user's position output from the position sensor 110 and information about a user's motion output from the motion sensor 120. The first communication module 210 may be an interface for directly or indirectly connecting the processor 200 with the position sensor 110 and the motion sensor 120. The first communication module 210 may transmit or receive data to or from the sensor 100 through wired and wireless networks or wired serial communication.

The memory 220 is used to store data necessary for performing the operation of the real 3D image generation system 10. In one embodiment, the memory 220 may be a least one of a hard disk drive (HDD), read only memory (ROM), random access memory (RAM), a flash memory, and a memory card as common storage media.

The memory 220 may be used to store image data such as data related to a specific image of an object. The specific image may include images representing the appearance and inside of an object, etc. Furthermore, if the object includes a plurality of entities, images of the plurality of entities may be stored in the memory 220. When an image of the same object is stored in the memory 220, the image may include a plurality of image data having different resolutions. The memory 220 may also store an algorithm or program being executed within the processor 200.

In addition, the memory 220 may prestore a look-up table that includes a user command is defined as, e.g., mapped to, at least one selected from the user's position and the user's motion. For example, if a user gazes at a region in a real 3D image, a user command corresponding to a gaze may be activated, and the resolution of the region may be increased in accordance with the user command.

The controller 230 determines the user command by using a look-up table and at least one selected from information about the user's position and information about the user's motion received from the sensor 100, and controls the processor 240 to generate an image signal, i.e., a computer generated hologram (CGH) in response to the user command.

The processor 240 may generate an image signal according to control by the controller 230 and by using image data stored in the memory 220. The image signal generated by the processor 240 may be delivered to the panel 300 that may then generate a real 3D image according to the image signal. For example, the processor 240 may read image data stored in the memory 220 to thereby generate an image signal having a first resolution. The processor 240 may also generate an image signal having a second resolution according to at least one selected from the user's position and the user's motion.

When a real 3D image is a holographic image, the image signal may be a CGH. In this case, the resolution of the holographic image may be determined by the CGH. In other words, as a spatial resolution of a real 3D image to be represented by a CGH increases, the resolution of a holographic image increases. When a real 3D image is a volumetric image, the resolution of the volumetric image may be determined by the number of pixels in a plurality of panels. In other words, as the degree to which images are projected in a time-sequential manner increase the resolution of a volumetric image may increase.

The second communication module 250 may transmit an image signal generated by the processor 240 to the panel 300. The second communication module 250 may be an interface for directly or indirectly connecting the processor 200 with the panel 300. The second communication module 250 may exchange data with the panel 300 through wired and wireless networks or wired serial communication.

The panel 300 may have a different construction according to whether it produces a holographic image or volumetric image.

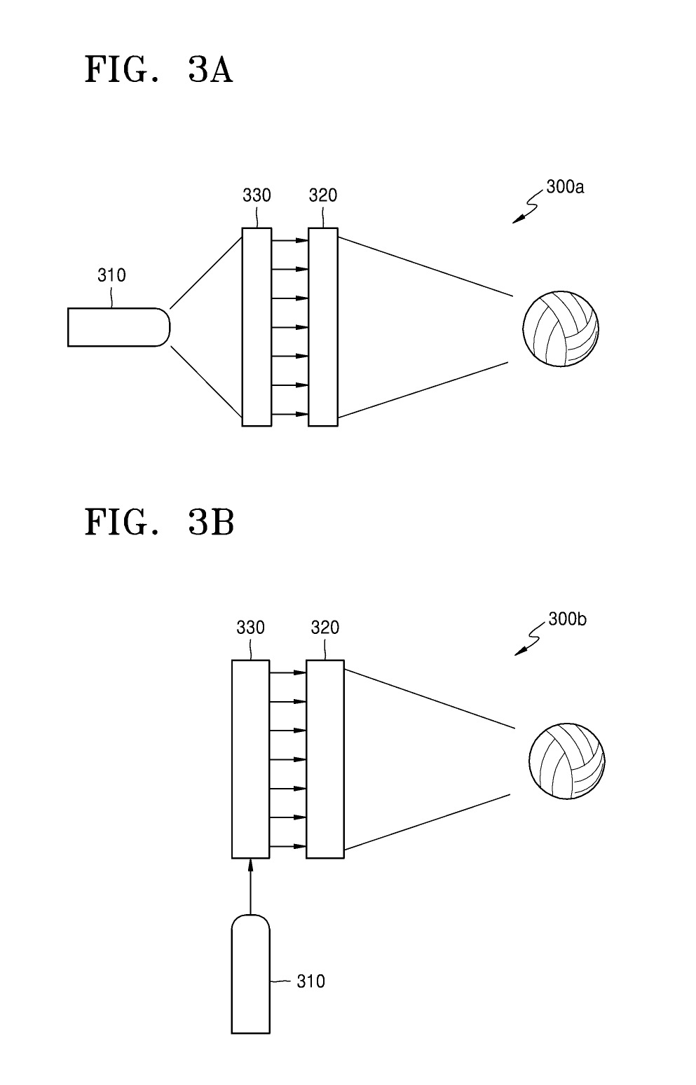

FIGS. 3A and 3B schematically illustrate panels 300a and 300b for generating a holographic image according to an exemplary embodiment. Referring to FIGS. 3A and 3B, the panel 300a or 300b may include a light source 310, a spatial optical modulator 320 for generating a holographic image by using light emitted from the light source 310, and an optical device 330 for increasing the quality of a holographic image or changing the direction of propagation of light.

As shown in FIG. 3A, the panel 300a may enlarge light emitted from the light source 310 for utilization. Furthermore, as shown in FIG. 3B, the panel 300b may be constructed to convert light emitted from the light source 310 into surface light by using the optical device 330.

The light source 310 may be a coherent laser light source, but is not limited thereto. The light source 310 may include a light-emitting diode (LED).

The spatial light modulator 320 modulates light incident from the light source 310 to thereby display an image signal, i.e., a CGH. The spatial light modulator 320 may modulate at least one selected from an amplitude and a phase of light according to a CGH. Light modulated by the spatial light modulator 320 may be used to produce a 3D image. An image generated by the spatial light modulator 320 may be formed in an imaging region. For example, the spatial light modulator 320 may include an optical electrical device that is used to change a refractive index according to an electrical signal. Examples of the spatial optical modulator 320 may include an electro-mechanical optical modulator, an acousto-optic modulator, and an electro-optic modulator such as a Micro Electro Mechanical Systems (MEMS) actuator array, a ferroelectric liquid crystal spatial light modulator (FLC SLM), an acousto-optic modulator (AOM), and modulators based on a liquid crystal display (LCD) and Liquid Crystal on Silicon (LCOS).

The spatial light modulator 320 may be a single spatial light modulator 320 that allows modulation of both or one of amplitude and phase or may have a modular structure including two or more elements.

The optical device 330 may include a collimating lens for collimating light and a field lens for providing a viewing window (viewing angle) of light that has passed through the spatial light modulator 320. The field lens may be a condensing lens that collects divergent light that is emitted from the light source 310 toward the viewing window. For example, the field lens may be formed as a diffractive optical element (DOE) or holographic optical element (HOE) that records a phase of a lens on a plane. The field lens may be disposed in front of the spatial light modulator 320. However, exemplary embodiments are not limited thereto, and both the collimating lens and the field lens may be disposed behind the spatial light modulator 320. Alternatively, all optical components may be disposed in front of or behind the spatial light modulator 320. The optical device 330 may further include additional components for removing diffracted light, speckles, twin images, etc.

The resolution of a holographic image may be determined by a CGH. In other words, with the increase in a spatial resolution of a real 3D image to be represented by a CGH, the resolution of the holographic image will increase. Furthermore, the resolution of a specific region in an image different from the resolution of the remaining region may be varied by generating more CGHs corresponding to the specific region.

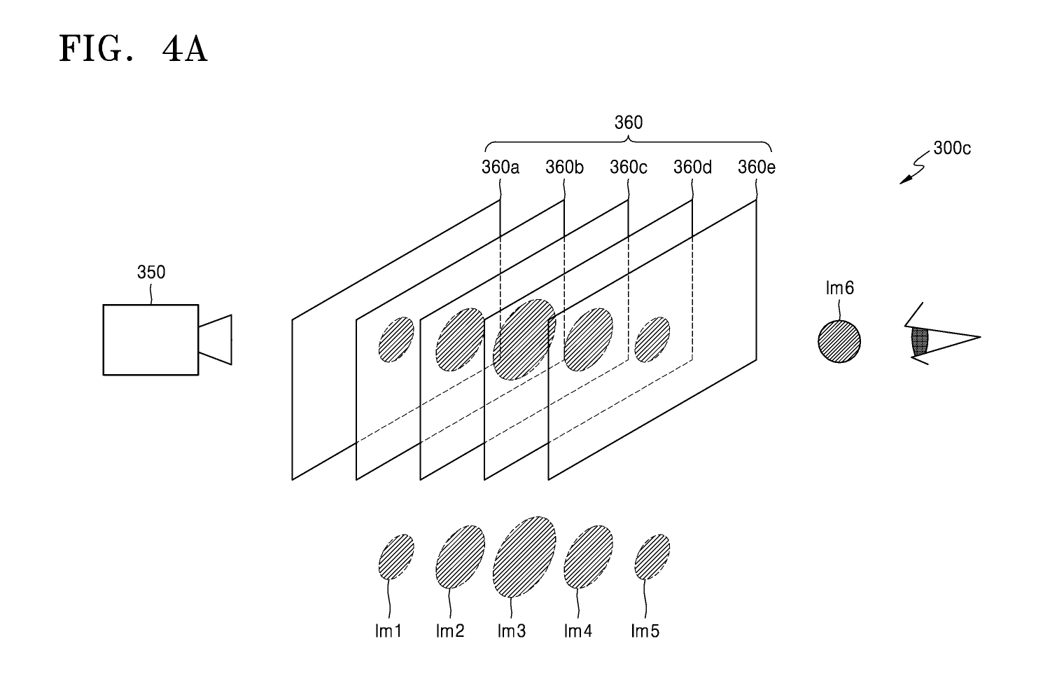

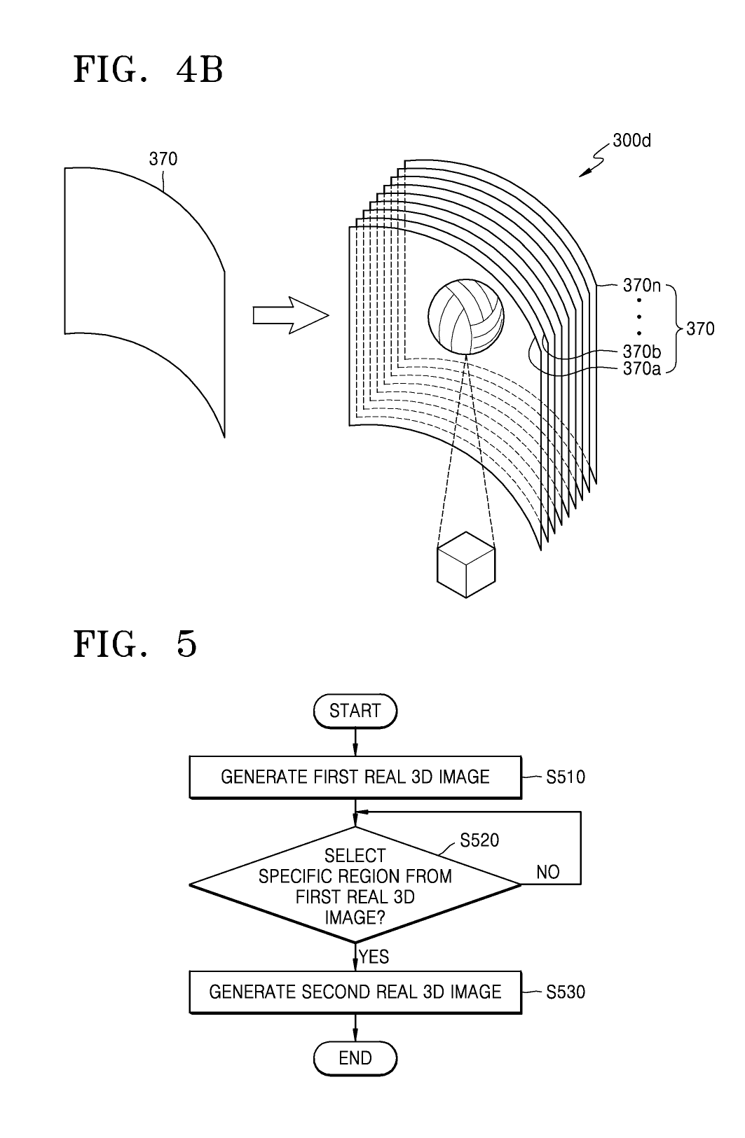

FIG. 4A schematically illustrates a panel 300c for generating a volumetric image according to an exemplary embodiment. Referring to FIG. 4A, the panel 300c may include a projector 350 for projecting an image corresponding to an image signal and a multi-planar optical panel 360 on which an image projected from the projector 350 is focused. The multi-planar optical panel 360 has a plurality of optical plates, i.e., first through fifth optical plates, 360a through 360e stacked on one another. For example, each of the first through fifth optical plates 360a through 360e may be a controllable, variable, and semi-transparent liquid crystal device. When turned off, the first through fifth optical plates 360a through 360e are in a transparent state. When turned on, the first through fifth optical plates 360a through 360e transit to an opaque light-scattering state. The first through fifth optical plates 360a through 360e may be controlled in this way so that images from the projector 350 are formed thereon.

In this structure, the projector 350 produces a 3D image on the multi-planar optical panel 360 by consecutively projecting a plurality of images, i.e., first through fifth images Im1 through Im5, having different depths onto the first through fifth optical plates 360a through 360e, respectively, by using a time-division technique. For example, the projector 350 may sequentially project the first through fifth images Im1 through Im5 onto the first through fifth optical plates 360a through 360e, respectively, by using a time-division technique. When each of the first through fifth images Im1 through Im5 is projected, a corresponding one of the first through fifth optical plates 360a through 360e enters an opaque light-scattering state. Then, the first through fifth images Im1 through Im5 are sequentially formed on the first through fifth optical plates 360a through 360e, respectively. When a plurality of images are projected within a very short time in this way, an observer feels the plurality of images as a single 3D image. Thus, a visual effect is obtained that allows the observer to feel as if a 3D object is created in a space.

FIG. 4B schematically illustrates a panel 300d according to another exemplary embodiment. Referring to FIG. 4B, the panel 300d may be formed by stacking a plurality of thin, transparent, flexible 2D display panels 370a through 370n without a gap therebetween. In this case, to stably maintain junctions between adjacent 2D display panels, a substrate in each of the 2D display panels 370a through 370n may have a small thermal expansion coefficient. In this structure, since the 2D display panels 370a through 370n are transparent, any of the images displayed on the 2D display panels 370a through 370n may be recognized by a user. Thus, the panel 300d may be considered to have pixels arranged in a 3D pattern. The panel 300d may provide an image having a greater sense of depth as the number of the 2D display panels 370a through 370e stacked increases. Other various types of panels may be used, but detailed descriptions thereof are omitted here.

To implement direct interaction with a real 3D image by using a user's hand, etc., a real or virtual image may be displayed by moving the volumetric image toward the user by using an optical method.

The resolution of a volumetric image may be determined by the number of pixels in an optical panel or a 2D display panel. For example, with the increase in the number of pixels in an optical panel or 2D display panel, the resolution of an image will increase. If an optical panel or 2D display panel includes a plurality of pixels, m pixels may operate to produce a volumetric image having a first resolution, and n pixels may also operate to generate a volumetric image having a second resolution. Here, m and n are natural numbers, and m is not equal to n. Alternatively, a plurality of pixels may be clustered into m groups, and the pixels in the m groups may operate to generate a volumetric image having a first resolution. A plurality of pixels may also be clustered into n groups, and the pixels in the n groups may operate to generate a volumetric image having a second resolution.

Furthermore, the resolution of an image different from the resolution of the remaining region may vary according to whether pixels corresponding to the region operate.

FIG. 5 is a flowchart of a method of generating a real 3D image according to an exemplary embodiment. Referring to FIGS. 2 and 5, the panel 300 generates a first real 3D image S510. For example, if the first real 3D image is a holographic image, the processor 240 may generate an image signal, i.e., a CGH having a lower resolution than the resolution of image data stored in the memory 220 and provide the image signal to the panel 300. Then, the panel 300 may generate a first holographic image by using coherent light and the CGH. The first holographic image may be formed in an imaging region. It is hereinafter assumed that a real 3D image is a holographic image. However, embodiments are not limited thereto. The method of FIG. 5 may be applied to all images containing a depth cue therein such as volumetric images. The depth cue may include a binocular depth cue and a monocular depth cue.

The controller 230 determines whether a user command is input that indicates selection of a specific region from the first real 3D image S520. The sensor 100 may detect at least one selected from the user's position and the user's motion, and a detection result is input to the controller 230 via the first communication module 210. The controller 230 may determine whether the detection result is a user command by using a look-up table. For example, if the detection result indicates a user′ gaze on a specific region, the controller 230 may determine whether the user's gaze on the region is registered with the look-up table as a user command.

If the user command indicating selection of the region from the first real 3D image is input S520-Y, the controller 230 may control the operation of the processor 240 so that the panel 300 generates a second real 3D image that is different from the first real 3D image in the region S530. The processor 240 reads image data from the memory 220 to thereby generate an image signal, i.e., a CGH corresponding to the second real 3D image. Then, the panel 300 may generate the second real 3D image according to the received image signal.

The second real 3D image may represent the same object as the first real 3D image. However, the second real 3D image may have a resolution different from that of the first real 3D image. For example, the second real 3D image may have a higher resolution than the first real 3D image.

In addition, if the object includes a plurality of entities, the first real 3D image may represent entities different from those of the second real 3D image. For example, if the object is a person, the object may include various entities including a person's skin, internal organs, bones, and blood vessels. In this case, the first and second real 3D images may demonstrate the appearance of the object such as the person's skin and the inside of the object such as the person's organs, respectively. Furthermore, if both the first and second real 3D images show the inside of the object, the first and second real 3D images may represent organs and blood vessels, respectively.

The second real 3D image may be generated by overlapping with the first real 3D image or replacing a portion of the first real 3D image with it.

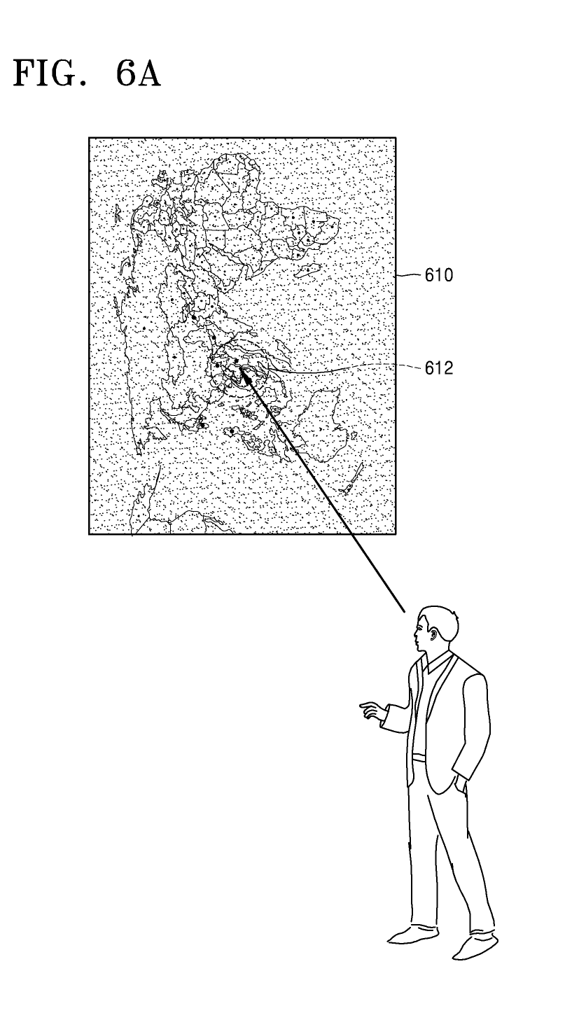

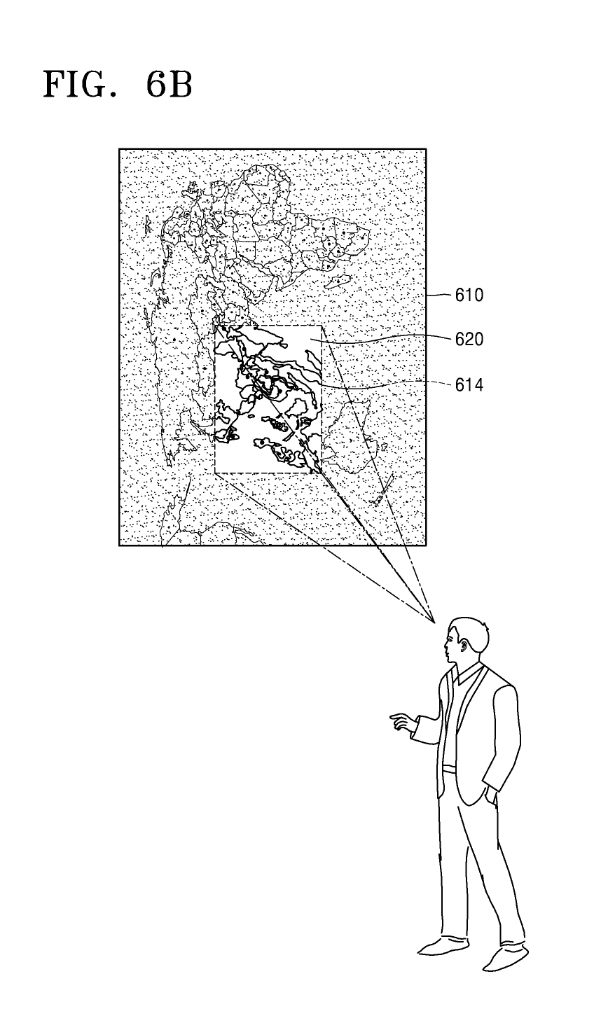

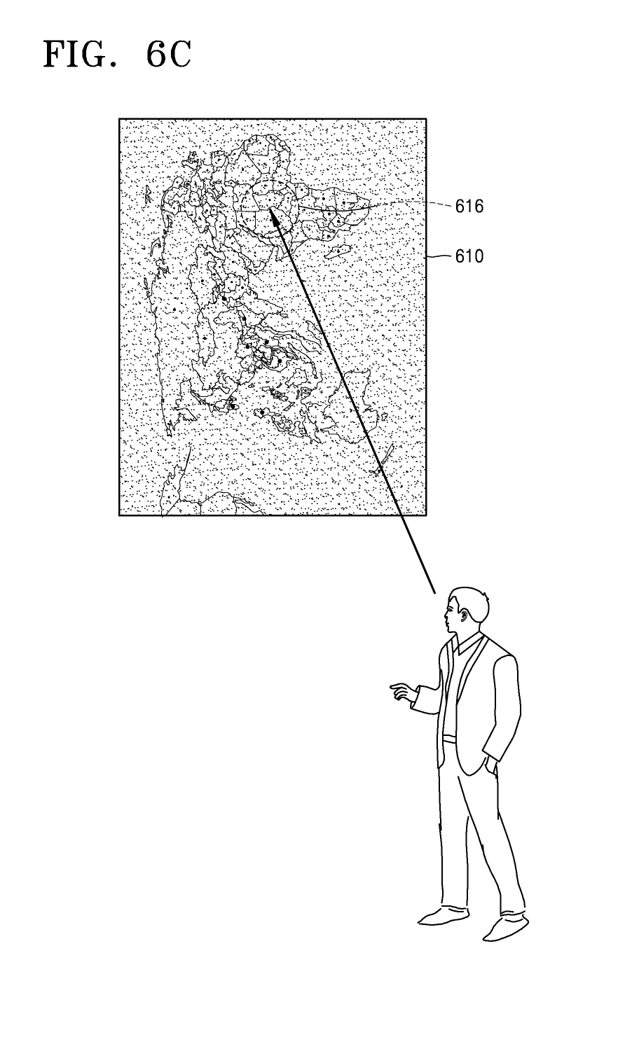

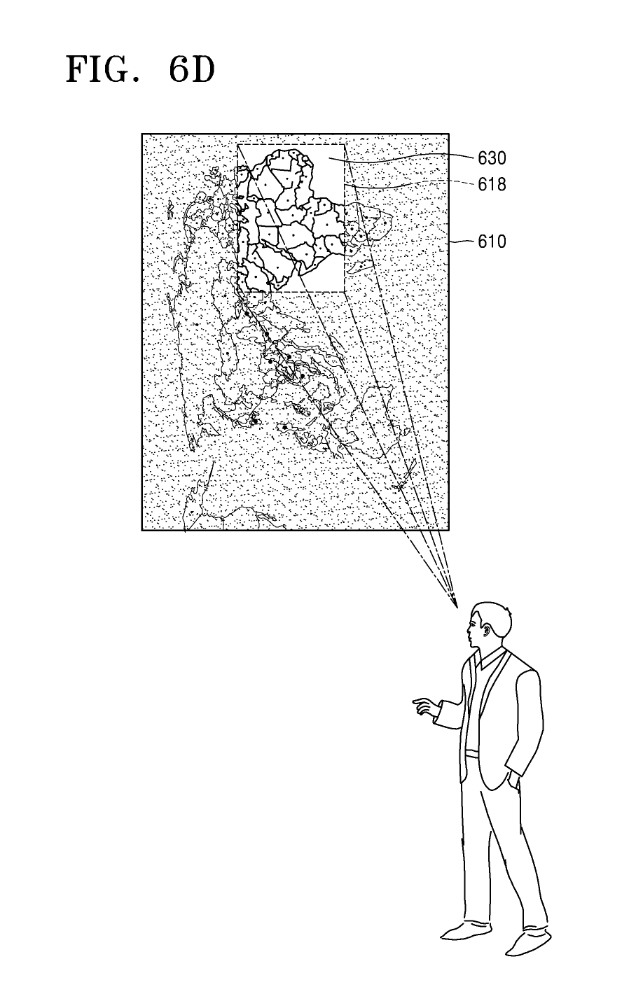

FIGS. 6A through 6D are diagrams for explaining a method of generating a real 3D image according to an exemplary embodiment. First, referring to FIGS. 2 and 6A, the real 3D image generation system 10 may generate a first real 3D image 610 on a space. The space may be separated from the panel 300 or included therein. The first real 3D image 610 may have a depth cue therein and a first resolution. The depth cue may include a binocular depth cue and a monocular depth cue.

A user may gaze at a first region 612 in the first real 3D image 610. For example, if the sensor 100 is an eye tracking sensor, the sensor 100 may detect a position of a user's pupil and a distance between the user and the first real 3D image 610 and transmit a detection result to the controller 230. The controller 230 may then determine a region where the user's gaze is directed (hereinafter, referred to as a user's gaze region) by using the detection result.

When the user's gaze behavior is registered with a look-up table as a user command indicating an increase in resolution, the controller 230 may control the processor 240 to generate an image signal corresponding to the user command. Then, the processor 240 may generate the image signal according to control by the controller 230 and apply the image signal to the panel 300. Referring to FIG. 6B, the panel 300 may generate a second real 3D image 620 in a second region 614. In this case, the second region 614 in which the second real 3D image 620 is formed does not necessarily coincide with the user's gaze region 612. The second region 614 may be slightly larger than the user's gaze region 612. The second real 3D image 620 may have a higher resolution than the first real 3D image 610. The resolution of the second real 3D image may increase in proportion to a duration of the user's gaze.

In this way, by making the resolution of a user's gaze region higher than that of the remaining region, a computational load necessary for generating a holographic image may be reduced. Since there may be a large signal processing load with respect to a holographic image, the signal processing load may be reduced by making only the resolution of a user's region of interest higher than that of the remaining region. Furthermore, when a volumetric image is generated, the signal processing load may be reduced by displaying the volumetric image at a low resolution with only a user's region of interest being displayed at a high resolution.

Furthermore, if the user's gaze region changes, a region having a higher resolution than the remaining region may vary. Referring to FIG. 6C, the user's gaze region may be changed to a third region 616 in the first real 3D image 610. Then, as shown in FIG. 6D, the panel 300 may generate a third real 3D image 630 in a fourth region 618. In this case, the third real 3D image 630 may have a higher resolution than the first real 3D image 610, and the fourth region 618 may be larger than the third region 616. Referring to FIG. 6D and FIG. 2, when the processor 200 recognizes that the user stops gazing at the first region 612 of FIG. 6A, the processor 200 may provide the first real 3D image formed in the first region 612, instead of providing the second real 3D image 620 of FIG. 6B. In other words, when the user stops gazing at the first region 612, the processor 200 may restore the resolution of the first real 3D image 610 to the original resolution. However, embodiments are not limited thereto. Even when a user's gaze is terminated, a region having a higher resolution than the remaining region may maintain the same resolution.

Furthermore, if a plurality of users are present, the resolution of a real 3D image may vary according to each of regions where gazes of the plurality of users are directed.

With reference to FIGS. 6A to 6D, the processor 200 is described as generating two different images, for example, the first real 3D image 610 and the second real 3D image 620, on the same panel 300. However, embodiments are not limited thereto. For example, the processor 200 may generate the first real 3D image 610 as an original version of a real 3D image as shown in FIG. 6A. In turn, the processor 200 may generate a new version of the real 3D image including the second region 614 and the remaining region that excludes the second region 614 from the entire region of the first real 3D image 610 as shown in FIG. 6B.

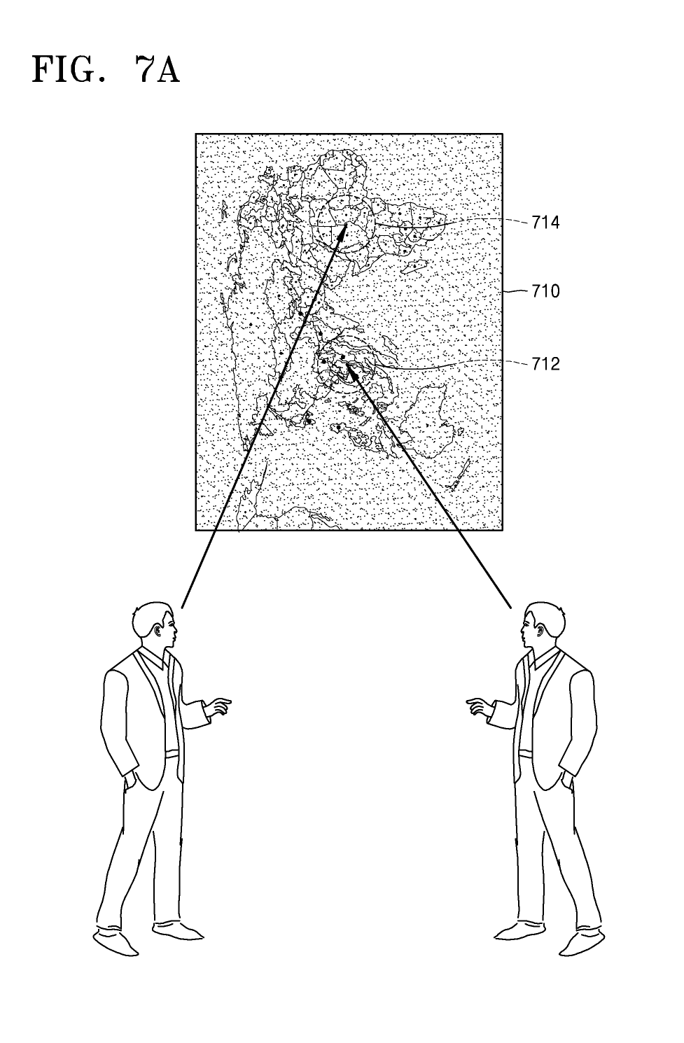

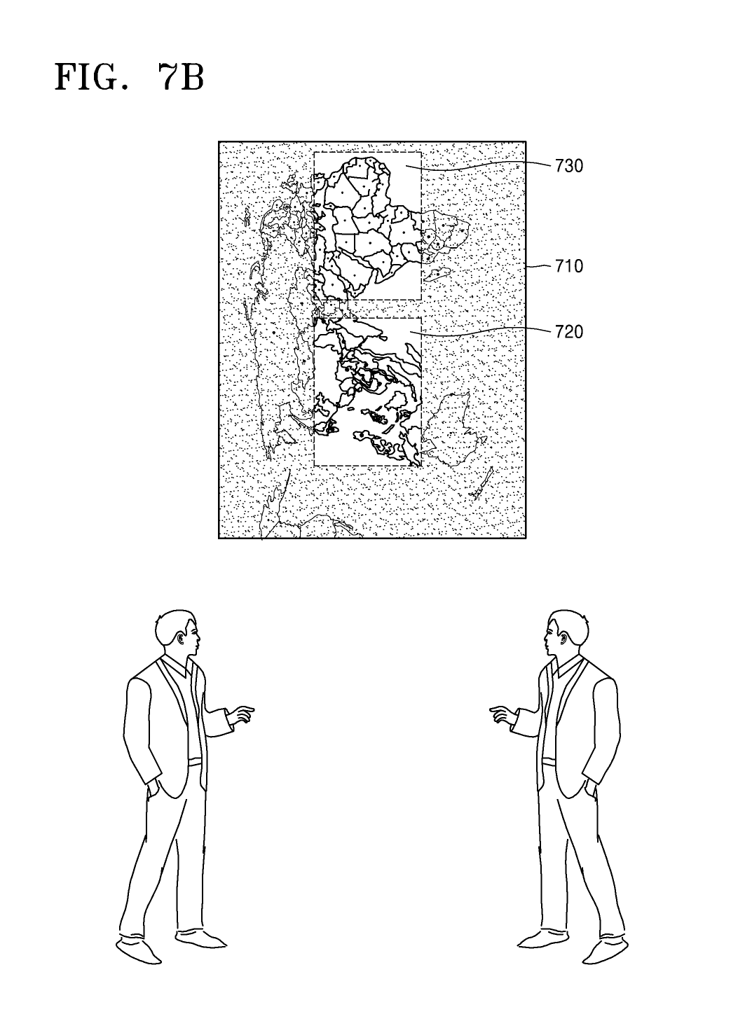

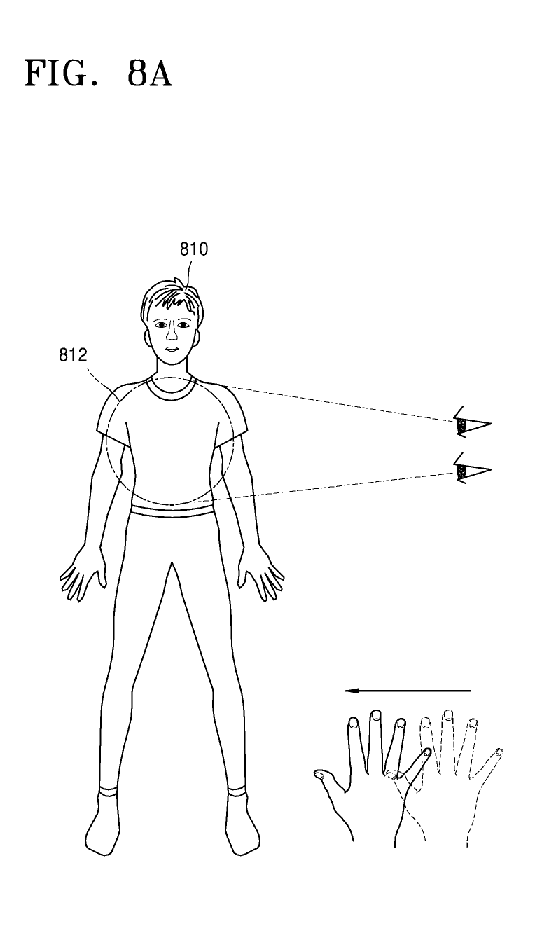

FIGS. 7A and 7B are diagrams for explaining a method of generating a real 3D image according to gazes of a plurality of users, according to an exemplary embodiment. First, referring to FIGS. 2 and 7A, the real 3D image generation system 10 may generate a first real 3D image 710 on a space. A first user may gaze at a first region 712 in the first real 3D image 710 while a second user may gaze at a second region 714 therein. Then, referring to FIGS. 2 and 7B, the panel 300 may generate a second real 3D image 720 having a higher resolution than the first real 3D image 710 in an area including the first region 712. The panel 300 may also generate a third real 3D image 730 having a higher resolution than the first real 3D image 710 in an area including the second region 714.

The real 3D image generation system 10 according to the present embodiment may generate not only real 3D images having different resolutions but also different types of real 3D images in specific regions.

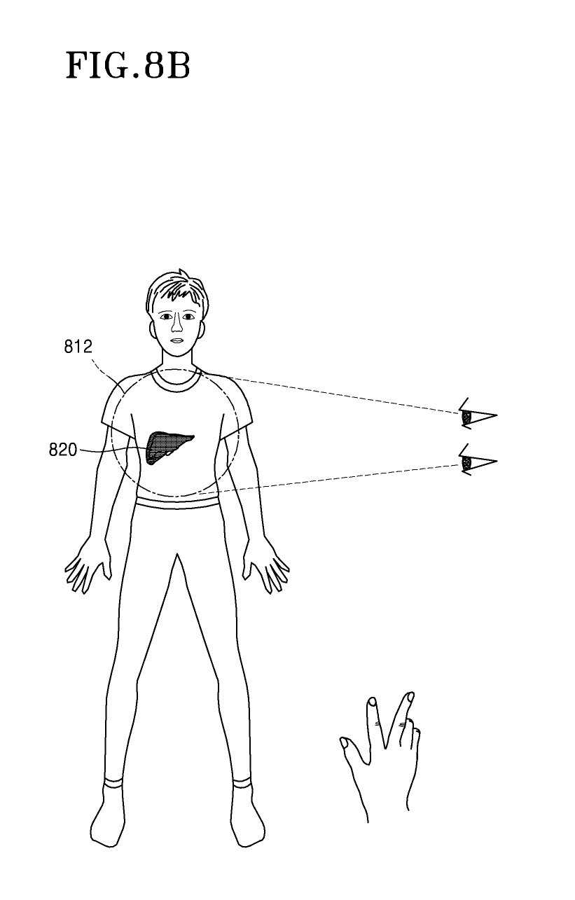

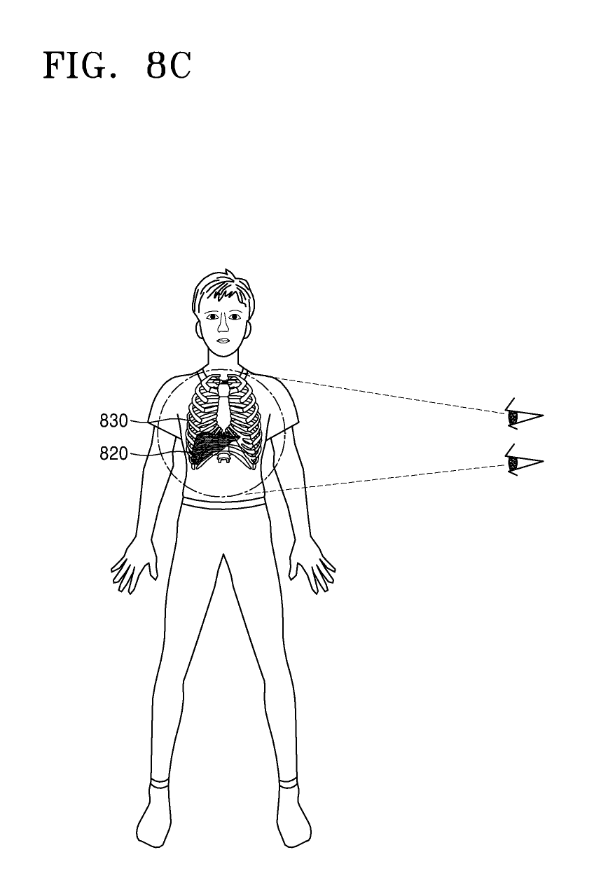

FIGS. 8A through 8C are diagrams for explaining a method of generating a real 3D image according to another exemplary embodiment. First, referring to FIGS. 2 and 8A, the real 3D image generation system 10 may generate a first real 3D image 810 on a space. The space may be separated from the panel 300 or included therein. The first real 3D image 810 may represent the appearance of an object.

A user may swing a hand while he or she is gazing at a specific region 812 in the first real 3D image 810. For example, if the sensor 100 includes an eye tracking sensor, the sensor 100 may detect a position of a user's pupil and a distance between the user and the first real 3D image 810 and transmit a detection result to the controller 230. The controller 230 may then determine a region where the user's gaze is directed (hereinafter, referred to as a user's gaze region) by using the detection result. In addition, if the sensor 100 includes an acceleration sensor or gyro sensor, the sensor 100 may detect a movement of a user's hand and transmit a detection result to the controller 230. The controller may then determine that the user's hand is swung from the detection result.

If swinging of a user's hand while the user is gazing at a specific region is registered with a look-up table as a user command specifying generation of an entity of an object in the specific region, the controller 230 may control the processor 240 to generate an image signal corresponding to the user command.

Then, the processor 240 may generate the image signal according to control by the controller 230 and apply the image signal to the panel 300. Referring to FIGS. 2 and 8B, the panel 300 may generate a second real 3D image 820 in the specific region. The second real 3D image 820 may represent an entity different from that of the first real 3D image 810. For example, the second real 3D image 820 may show the inside of an object, in particular, an internal organ of the object.

Furthermore, the user may spread two fingers while gazing at a specific region in the second real 3D image 820. Then, the sensor 100 may detect a movement of the user's two fingers and transmit a detection result to the controller 230. The controller 230 may then recognize that the user's two fingers are spread from the detection result.

If spreading of user's two fingers while gazing at a specific region is registered with a look-up table as a user command specifying additional generation of another entity of an object in the specific region, the controller 230 may control the processor 240 to generate an image signal corresponding to the user command.

Then, the processor 240 may generate the image signal according to control by the controller 230 and apply the image signal to the panel 300. Referring to FIGS. 2 and 8C, the panel 300 may generate a third real 3D image 830 in the specific region. The third real 3D image 830 may represent an entity different from that of the second real 3D image 820. Even if both the second and third real 3D images 820 and 830 represent the inside of the object, the second real 3D image 820 may be an image of the liver, and the third real 3D image may be an image of bones.

While FIGS. 8A through 8C show that different types of real 3D images are generated according to a single user's gaze and motion, exemplary embodiments are not limited thereto. Different types of real 3D images may be produced according to gazes or motions of a plurality of users. For example, a second real 3D image may be generated by a first user's gaze, and a third real 3D image may be generated by a second user's motion.

According to the methods according to exemplary embodiments, a real 3D image may be generated in only a user's region of interest. Thus, a computational load necessary for generating a real 3D image may be reduced.

Furthermore, the real 3D image may be used as a medical image, but is not limited thereto. The real 3D image may be applied to other various fields such as education or entertainment.

While one or more exemplary embodiments have been described with reference to the figures, it will be understood by one of ordinary skill in the art that various changes in form and details may be made therein without departing from the spirit and scope of the present invention as defined by the following claims. Thus, it should be understood that the exemplary embodiments described herein should be considered in a descriptive sense only and not for purposes of limitation. The scope of the invention is defined not by the detailed description of the invention but by the appended claims, and all differences within the scope of the appended claims and their equivalents will be construed as being included in the present invention.

What is claimed is:

1. A method of generating a three-dimensional (3D) image, the method comprising:
generating a first 3D image having a first binocular depth cue and a first monocular depth cue; and
generating, in a first region, a second 3D image that has a second binocular depth cue and a second monocular depth cue, and is different from the first 3D image, in response to a user command being input which indicates that the first region is selected from the first 3D image,
wherein the first and the second 3D images represent a same object.

2. The method of claim 1, further comprising, generating, in a second region, a third 3D image that has a third binocular depth cue and a third monocular depth cue, and is different from the first 3D image, in response to a user command being input which indicates that the second region is selected from the first 3D image,
wherein the first and the third 3D images represent the same object.

3. The method of claim 2, wherein the user command indicating that the first region is selected and the user command indicating that the second region is selected are input by different users.

4. The method of claim 1, wherein the second 3D image has a second resolution that is different from a first resolution of the first 3D image.

5. The method of claim 4, wherein the second resolution is higher than the first resolution.

6. The method of claim 1, wherein the first and the second 3D images show different entities of the same object.

7. The method of claim 6, wherein the first 3D image shows an appearance of the same object, and the second 3D image shows an inside of the same object.

8. The method of claim 6, wherein the first and the second 3D images show a first entity and a second entity contained inside the same object, respectively.

9. The method of claim 1, wherein the second 3D image is generated in the first region by overlapping with the first 3D image.

10. The method of claim 1, wherein the second 3D image is displayed in the first region by replacing a portion of the first 3D image.

11. The method of claim 1, wherein the first region is determined by at least one from among a user's gaze and a user's motion.

12. The method of claim 11, wherein the first region is a region indicated by a portion of a user's body or by an indicator held by the user.

13. The method of claim 12, wherein the portion of the user's body comprises at least one from among a user's pupil and a user's finger.

14. The method of claim 11, wherein the second 3D image varies according to the user's motion.

15. The method of claim 1, wherein the first or the second 3D image is generated using a computer generated hologram (CGH).

16. The method of claim 1, wherein the first and the second 3D images are medical images.

17. A system for generating a three-dimensional (3D) image, the system comprising:
a panel configured to generate a first 3D image; and
a sensor configured to detect at least one from among a user's pupil position and a user's motion,
wherein the panel generates a second 3D image different from the first 3D image in a first region, in response to a result of the detection indicating that the first region is selected from the first 3D image.

18. The system of claim 17, wherein the second 3D image represents a same object as the first 3D image and has a second resolution that is different from a first resolution of the first 3D image.

19. The system of claim 18, wherein the first and the second 3D images show different entities of the same object.

20. The system of claim 18, wherein the first 3D image shows an appearance of the same object, and the second 3D image shows an inside the same object.

21. A system for generating a three-dimensional (3D) image, the system comprising:
a sensor configured to detect a pupil position or a hand gesture of a user; and
a processor configured to generate an original version of a 3D image and to generate a new version of the 3D image in response to the detected pupil position or the hand gesture indicating that the user selects a region of the original version of the 3D image,
wherein the new version is provided with a remaining region having a resolution that is the same as a resolution of the original version and the selected region having a resolution that is a higher than the resolution of the original version.

22. The system of claim 21, wherein the processor generates the new version in response to the detected pupil position indicating that the user gazes at the selected region of the original version.

23. The system of claim 21, wherein the processor generates the new version in response to the detected hand gesture further indicating that two fingers of the user spread while the user gazes at the selected region of the original version.
